(19) United States
(12) Patent Application Publication
(10) Pub. No.: US 2021/0152848 A1
(43) Pub. Date: May 20, 2021

(54) IMAGE PROCESSING DEVICE, IMAGE PROCESSING METHOD, PROGRAM, AND IMAGE TRANSMISSION SYSTEM

(71) Applicant: SONY CORPORATION, TOKYO (JP)

(72) Inventor: HIROKI MIZUNO, TOKYO (JP)

(21) Appl. No.: 17/045,007

(22) PCT Filed: Mar. 27, 2019
(86) PCT No.: PCT/JP2019/013066

§ 371 Date: Oct. 2, 2020

(30) Foreign Application Priority Data
Apr. 10, 2018 (JP) 2018-075461

(51) Int. Cl. H04N 19/597; H04N 19/167; G06T 7/55; H04N 13/15; H04N 19/30; H04N 13/282; H04N 13/243

(52) U.S. Cl. CPC H04N 19/597; H04N 19/167; G06T 7/55; G06T 2207/10028; H04N 19/30; H04N 13/282; H04N 13/243; H04N 13/15

(57) ABSTRACT

The present disclosure relates to an image processing device, an image processing method, a program, and an image transmission system that can achieve a higher compression efficiency. A compression rate higher than a compression rate for a non-overlapping region is set for an overlapping region in which an image captured by a reference camera, which serves as a reference, of N cameras and an image captured by a non-reference camera other than the reference camera overlap each other. The image is compressed at each of the compression rates. The present technology is applicable to, for example, an image transmission system configured to transmit an image to be displayed on a display capable of expressing a three-dimensional space.

### TECHNICAL FIELD

The present disclosure relates to an image processing device, an image processing method, a program, and an image transmission system, and in particular, to an image processing device, an image processing method, a program, and an image transmission system that can achieve a higher compression efficiency.

### BACKGROUND ART

In recent years, technologies related to AR (Augmented Reality), VR (Virtual Reality), and MR (Mixed Reality) and technologies related to stereoscopic displays configured to three-dimensionally display videos have been developed. Such technological development has leaded to the development of displays capable of presenting, to viewers, stereoscopic effects, the sense of reality, and the like that related-art displays configured to perform two-dimensional display have not been able to express.

For example, as means for displaying states of the real world on a display capable of expressing three-dimensional spaces, there is a method that utilizes a multiview video obtained by synchronously capturing a scene by a plurality of cameras arranged in the scene as a capturing subject. Meanwhile, in a case where a multiview video is used, a video data amount increases significantly, and an effective compression technology is therefore demanded.

Thus, as a method of compressing multiview videos, by H.264/MVC (Multi View Coding), a compression rate enhancement method utilizing a characteristic that videos at respective viewpoints are similar to each other is standardized. Since this method expects that videos captured by cameras are similar to each other, it is expected that the method is highly effective in a case where baselines between cameras are short but provides low compression efficiency in a case where cameras are used in a large space and baselines between the cameras are long.

In view of this, as disclosed in PTL 1, there has been proposed an image processing system configured to separate the foreground and background of a video and compress the foreground and the background at different compression rates, to thereby reduce the data amount of the entire system. This image processing system is highly effective in a case where a large scene such as a stadium is to be captured and the background region is overwhelmingly larger than the foreground region including persons, for example.

### CITATION LIST

### Patent Literature

[PTL 1]

Japanese Patent Laid-Open No. 2017-211828

### SUMMARY

### Technical Problem

Incidentally, it is expected that the image processing system proposed in PTL 1 described above provides low compression efficiency in a scene in which a subject corresponding to the foreground region in a captured image is dominant in the picture frame, for example.

The present disclosure has been made in view of such a circumstance and can achieve a higher compression efficiency.

### Solution to Problem

According to a first aspect of the present disclosure, there is provided an image processing device including a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and a compression unit configured to compress the image at each of the compression rates.

According to the first aspect of the present disclosure, there is provided an image processing method including, by an image processing device which compresses an image, setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and compressing the image at each of the compression rates.

According to the first aspect of the present disclosure, there is provided a program causing a computer of an image processing device which compresses an image to execute image processing including setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and compressing the image at each of the compression rates.

In the first aspect of the present disclosure, a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, is set higher than a compression rate for a non-overlapping region. The image is compressed at each of the compression rates.

According to a second aspect of the present disclosure, there is provided an image processing device including a determination unit configured to determine, for each of a plurality of images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject, a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and a generation unit configured to generate the virtual viewpoint video on the basis of the color decided by the decision unit.

According to the second aspect of the present disclosure, there is provided an image processing method including, by an image processing device which generates an image, determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject, performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and generating the virtual viewpoint video on the basis of the color decided.

According to the second aspect of the present disclosure, there is provided a program causing a computer of an image processing device which generates an image to execute image processing including determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject, performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and generating the virtual viewpoint video on the basis of the color decided.

In the second aspect of the present disclosure, for each of a plurality of images obtained by capturing a subject from a plurality of viewpoints, whether a predetermined position of the subject from an arbitrary viewpoint on a virtual viewpoint video is a visible region or an invisible region in each of a plurality of imaging devices is determined on the basis of information indicating a three-dimensional shape of the subject. A weighted average is performed using weight information based on a compression rate used in compressing a position corresponding to the predetermined position determined as the visible region on each of the plurality of images, and color information indicating a color at the position corresponding to the predetermined position on each image, to thereby decide a color at the predetermined position of the virtual viewpoint video. The virtual viewpoint video is generated on the basis of the color decided.

According to a third aspect of the present disclosure, there is provided an image transmission system including: a first image processing device including a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and a compression unit configured to compress the image at each of the compression rates; and a second image processing device including a determination unit configured to determine, for each of the plurality of images transmitted from the first image processing device, whether a predetermined position of the subject from an arbitrary viewpoint on a virtual viewpoint video is a visible region or an invisible region in each of the plurality of the imaging devices on the basis of information indicating a three-dimensional shape of the subject, a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and a generation unit configured to generate the virtual viewpoint video on the basis of the color decided by the decision unit.

In the third aspect of the present disclosure, in the first image processing device, a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, is set higher than a compression rate for a non-overlapping region. The image is compressed at each of the compression rates. Moreover, in the second image processing device, for each of the plurality of images transmitted from the first image processing device, whether a predetermined position of the subject from an arbitrary viewpoint on a virtual viewpoint video is a visible region or an invisible region in each of the plurality of the imaging devices is determined on the basis of information indicating a three-dimensional shape of the subject. A weighted average is performed using weight information based on a compression rate used in compressing a position corresponding to the predetermined position determined as the visible region on each of the plurality of images, and color information indicating a color at the position corresponding to the predetermined position on each image, to thereby decide a color at the predetermined position of the virtual viewpoint video. The virtual viewpoint video is generated on the basis of the color decided.

### Advantageous Effect of Invention

According to the first to third aspects of the present disclosure, it is possible to achieve a higher compression efficiency.

Note that the effect described here is not necessarily limited and may be any effects described in the present disclosure.

### BRIEF DESCRIPTION OF DRAWINGS

FIG. 1 is a block diagram illustrating a configuration example of a first embodiment of an image transmission system to which the present technology is applied.

FIG. 2 is a diagram illustrating a deployment example of a plurality of cameras.

FIG. 3 is a block diagram illustrating a configuration example of a video compression unit.

FIG. 4 is a block diagram illustrating a configuration example of a virtual viewpoint video generation unit.

FIG. 5 is a diagram illustrating an example of overlapping regions and non-overlapping regions.

FIG. 6 is a diagram illustrating an overlap determination method.

FIG. 7 is a flowchart illustrating compressed video generation processing.

FIG. 8 is a flowchart illustrating virtual viewpoint video generation processing.

FIG. 9 is a flowchart illustrating color information and weight information acquisition processing.

FIG. 10 is a block diagram illustrating a configuration example of a second embodiment of the image transmission system.

FIG. 11 is a block diagram illustrating a configuration example of a third embodiment of the image transmission system.

FIG. 12 is a block diagram illustrating a configuration example of a fourth embodiment of the image transmission system.

FIG. 13 is a block diagram illustrating a configuration example of a fifth embodiment of the image transmission system.

FIG. 14 is a diagram illustrating a deployment example in which a plurality of cameras is arranged to surround a subject.

FIG. 15 is a diagram illustrating overlapping regions when two reference cameras are used.

FIG. 16 is a block diagram illustrating a configuration example of one embodiment of a computer to which the present technology is applied.

### DESCRIPTION OF EMBODIMENTS

Now, specific embodiments to which the present technology is applied are described in detail with reference to the drawings.

<First Configuration Example of Image Transmission System>

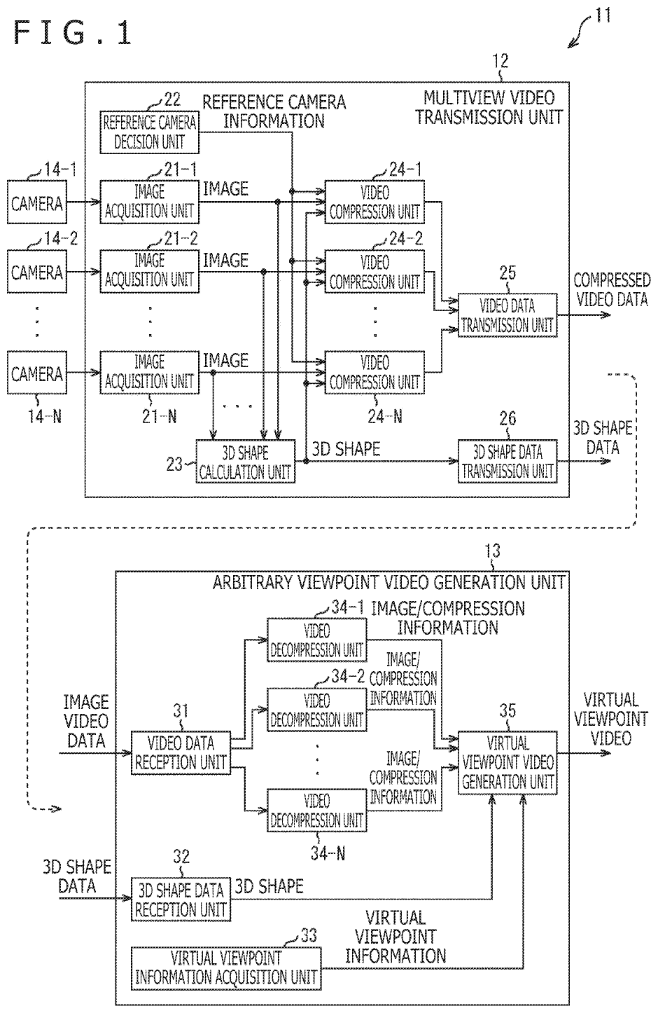

FIG. 1 is a block diagram illustrating a configuration example of a first embodiment of an image transmission system to which the present technology is applied.

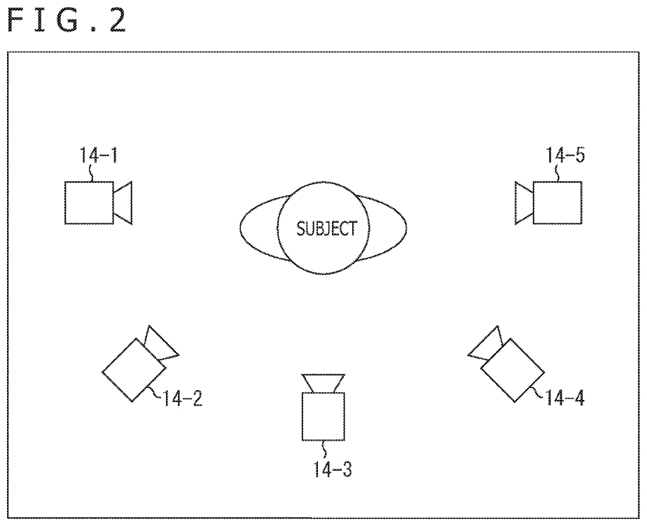

As illustrated in FIG. 1, an image transmission system 11 includes a multiview video transmission unit 12 configured to transmit a multiview video obtained by capturing a subject from multiple viewpoints, and an arbitrary viewpoint video generation unit 13 configured to generate a virtual viewpoint video that is a video of a subject virtually seen from an arbitrary viewpoint to present the virtual viewpoint video to a viewer. Further, in the image transmission system 11, N cameras 14-1 to 14-N are connected to the multiview video transmission unit 12. For example, as illustrated in FIG. 2, a plurality of cameras 14 (five cameras 14-1 to 14-5 in the example of FIG. 2) is arranged at a plurality of positions around a subject.

For example, in the image transmission system 11, compressed video data that is a compressed multiview video including N images obtained by capturing a subject by the N cameras 14-1 to 14-N from N viewpoints, and 3D shape data regarding the subject are transmitted from the multiview video transmission unit 12 to the arbitrary viewpoint video generation unit 13. Then, in the image transmission system 11, a high-quality virtual viewpoint video is generated from the compressed video data and the 3D shape data by the arbitrary viewpoint video generation unit 13 to be displayed on a display device (not illustrated) such as a head mounted display, for example.

The multiview video transmission unit 12 includes N image acquisition units 21-1 to 21-N, a reference camera decision unit 22, a 3D shape calculation unit 23, N video compression units 24-1 to 24-N, a video data transmission unit 25, and a 3D shape data transmission unit 26.

The image acquisition units 21-1 to 21-N acquire images obtained by capturing a subject by the corresponding cameras 14-1 to 14-N from the N viewpoints. Then, the image acquisition units 21-1 to 21-N supply the acquired images to the 3D shape calculation unit 23 and the corresponding video compression units 24-1 to 24-N.

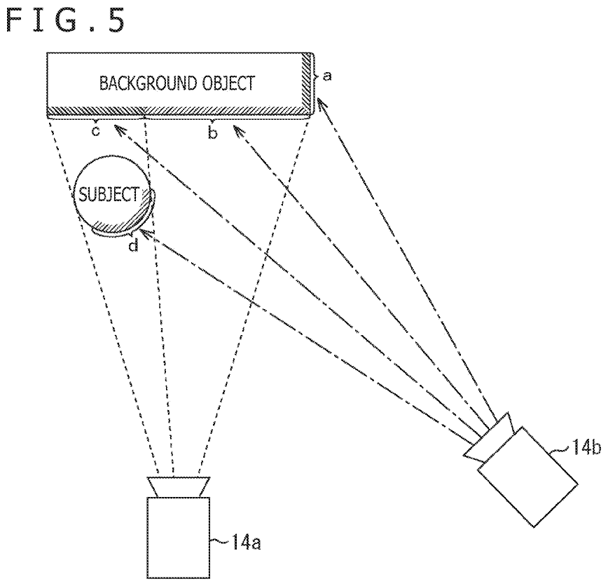

The reference camera decision unit 22 decides any one of the N cameras 14-1 to 14-N as a reference camera 14a serving as a reference in determining overlapping regions in which an image captured by the camera in question and images captured by other cameras overlap each other (see the reference camera 14a illustrated in FIG. 5 described later). Then, the reference camera decision unit 22 supplies, to the video compression units 24-1 to 24-N, reference camera information specifying the reference camera 14a of the cameras 14-1 to 14-N. Note that the cameras 14-1 to 14-N other than the reference camera 14a are hereinafter referred to as non-reference camera 1b appropriately (see the non-reference camera 1b illustrated in FIG. 5 described later).

The 3D shape calculation unit 23 performs calculation based on images at the N viewpoints supplied from the image acquisition units 21-1 to 21-N to acquire a 3D shape expressing a subject as a three-dimensional shape and supplies the 3D shape to the video compression units 24-1 to 24-N and the 3D shape data transmission unit 26.

For example, the 3D shape calculation unit 23 acquires the 3D shape of a subject by Visual Hull that projects a silhouette of a subject at each viewpoint to a 3D space and forms the intersection region of the silhouettes as a 3D shape, Multi view stereo that utilizes consistency of texture information between viewpoints, or the like. Note that, to achieve the processing of Visual Hull, Multi view stereo, or the like, the 3D shape calculation unit 23 needs the internal parameters and external parameters of each of the cameras 14-1 to 14-N. Such information is known through calibration, which is performed in advance. For example, as the internal parameters, camera-specific values such as focal lengths, image center coordinates, or aspect ratios are used. As the external parameters, vectors indicating an orientation and position of a camera in the world coordinate system are used.

The video compression units 24-1 to 24-N receive images captured by the corresponding cameras 14-1 to 14-N from the image acquisition units 21-1 to 21-N. Further, the video compression units 24-1 to 24-N receive reference camera information from the reference camera decision unit 22, and the 3D shape of a subject from the 3D shape calculation unit 23. Then, the video compression units 24-1 to 24-N compress, on the basis of the reference camera information and the 3D shape of the subject, the images captured by the corresponding cameras 14-1 to 14-N, and supply compressed videos acquired as a result of the compression to the video data transmission unit 25.

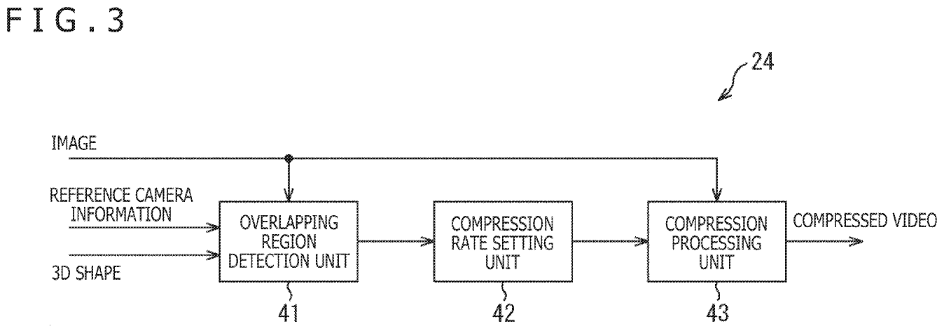

Here, as illustrated in FIG. 3, the video compression units 24 each include an overlapping region detection unit 41, a compression rate setting unit 42, and a compression processing unit 43.

First, the overlapping region detection unit 41 detects, on the basis of the 3D shape of a subject, overlapping regions between an image captured by the reference camera 14a and an image captured by the non-reference camera 1b. Then, in compressing the image captured by the non-reference camera 1b, the compression rate setting unit0 42 sets, for the overlapping regions, a compression rate higher than a compression rate for non-overlapping regions. For example, it is expected that, when the cameras 14-1 to 14-5 are arranged as illustrated in FIG. 2, images captured by the respective cameras 14-1 to 14-5 include a large number of overlapping regions in which the images overlap each other with respect to the subject. In such a circumstance, in compressing an image captured by the non-reference camera 1b, a compression rate for the overlapping regions is set higher than a compression rate for non-overlapping regions, so that the compression efficiency of the entire image transmission system 11 can be enhanced.

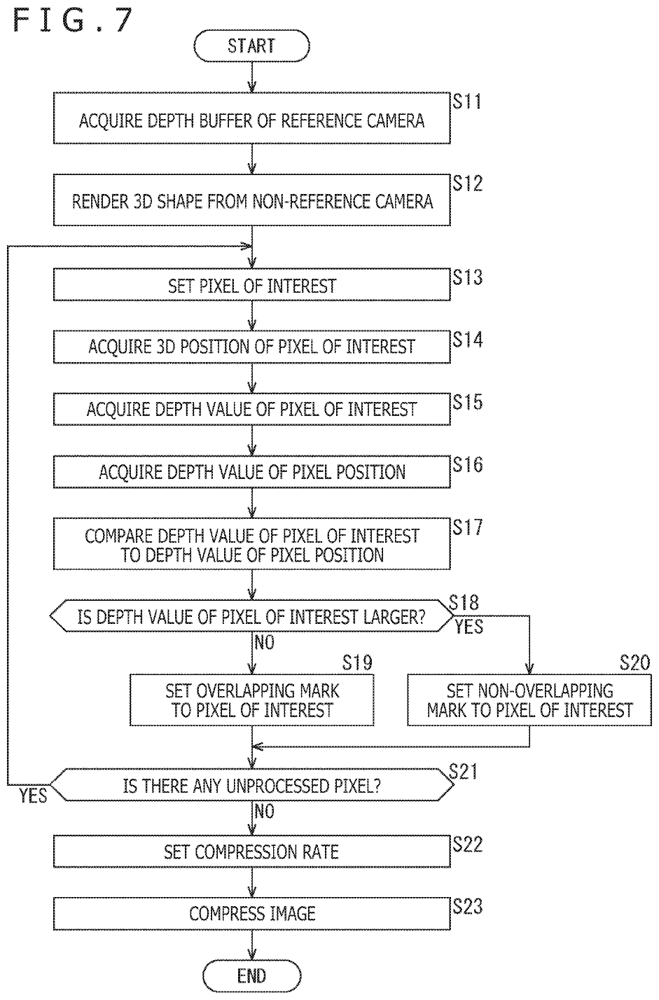

When the compression rate setting unit 42 sets compression rates for overlapping regions and non-overlapping regions in this way, the compression processing unit 43 performs the compression processing of compressing an image at each of the compression rates, to thereby acquire a compressed video. Here, the compression processing unit 43 provides the compressed video with compression information indicating the compression rates for the overlapping regions and the non-overlapping regions. Note that the compressed video generation processing that the video compression unit 24 performs to generate compressed videos is described later with reference to the flowchart of FIG. 7.

Note that it is assumed that, as the compression technology that is used by the video compression units 24-1 to 24-N, a general video compression codec such as H.264/AVC (Advanced Video Coding) or H.265/HEVC (High Efficiency Video Coding) is utilized, but the compression technology is not limited thereto.

The video data transmission unit 25 combines N compressed videos supplied from the video compression units 24-1 to 24-N to convert the N compressed videos to compressed video data to be transmitted, and transmits the compressed video data to the arbitrary viewpoint video generation unit 13.

The 3D shape data transmission unit 26 converts a 3D shape supplied from the 3D shape calculation unit 23 to 3D shape data to be transmitted, and transmits the 3D shape data to the arbitrary viewpoint video generation unit 13.

The arbitrary viewpoint video generation unit 13 includes a video data reception unit 31, a 3D shape data reception unit 32, a virtual viewpoint information acquisition unit 33, N video decompression units 34-1 to 43-N, and a virtual viewpoint video generation unit 35.

The video data reception unit 31 receives compressed video data transmitted from the video data transmission unit 25, divides the compressed video data into N compressed videos, and supplies the N compressed videos to the video decompression units 34-1 to 43-N.

The 3D shape data reception unit 32 receives 3D shape data transmitted from the 3D shape data transmission unit 26, and supplies the 3D shape of a subject based on the 3D shape data to the virtual viewpoint video generation unit 35.

The virtual viewpoint information acquisition unit 33 acquires, depending on the motion or operation of the viewer, for example, on the posture of the head mounted display, virtual viewpoint information indicating a viewpoint from which the viewer virtually sees a subject in a virtual viewpoint video, and supplies the virtual viewpoint information to the virtual viewpoint video generation unit 35.

The video decompression units 34-1 to 43-N receive, from the video data reception unit 31, compressed videos obtained by compressing images obtained by capturing a subject by the corresponding cameras 14-1 to 14-N from the N viewpoints. Then, the video decompression units 34-1 to 43-N decompress the corresponding compressed videos in accordance with a video compression codec utilized by the video compression units 24-1 to 24-N, to thereby acquire N images, and supplies the N images to the virtual viewpoint video generation unit 35. Further, the video decompression units 34-1 to 43-N acquire respective pieces of compression information given to the corresponding compressed videos, and supplies the pieces of compression information to the virtual viewpoint video generation unit 35.

Here, the compressed videos are individually subjected to the compression processing in the video compression units 24-1 to 24-N, and the video decompression units 34-1 to 43-N can individually decompress the compressed videos without data communication therebetween. That is, the video decompression units 34-1 to 43-N can perform the decompression processing in parallel, with the result that a processing time of the entire image transmission system 11 can be shortened.

The virtual viewpoint video generation unit 35 generates, on the basis of the 3D shape of a subject supplied from the 3D shape data reception unit 32 and virtual viewpoint information supplied from the virtual viewpoint information acquisition unit 33, virtual viewpoint videos by referring to respective pieces of compression information corresponding to N images.

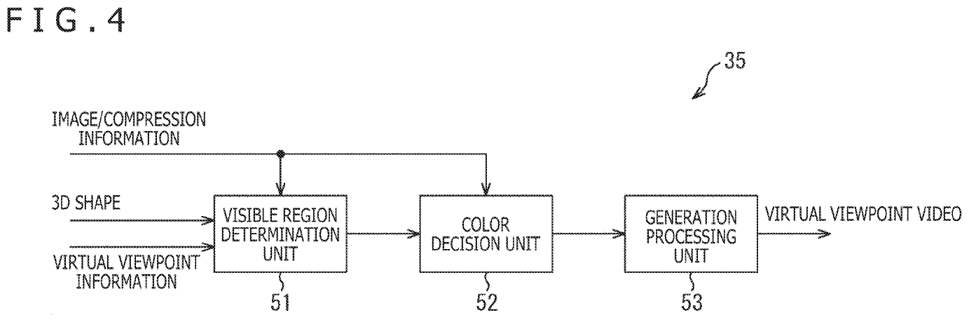

Here, as illustrated in FIG. 4, the virtual viewpoint video generation unit 35 includes a visible region determination unit 51, a color decision unit 52, and a generation processing unit 53.

For example, the visible region determination unit 51 determines, for each of N images, whether a predetermined position on a virtual viewpoint video is a visible region or an invisible region in each of the cameras 14-1 to 14-N on the basis of the 3D shape of a subject. Further, the color decision unit 52 acquires, from compression information, a compression rate used in compressing a position corresponding to the predetermined position determined as the visible region on each of the N images, to thereby acquire weight information based on each compression rate. In addition, the color decision unit 52 acquires color information indicating a color at the position corresponding to the predetermined position determined as the visible region on each image.

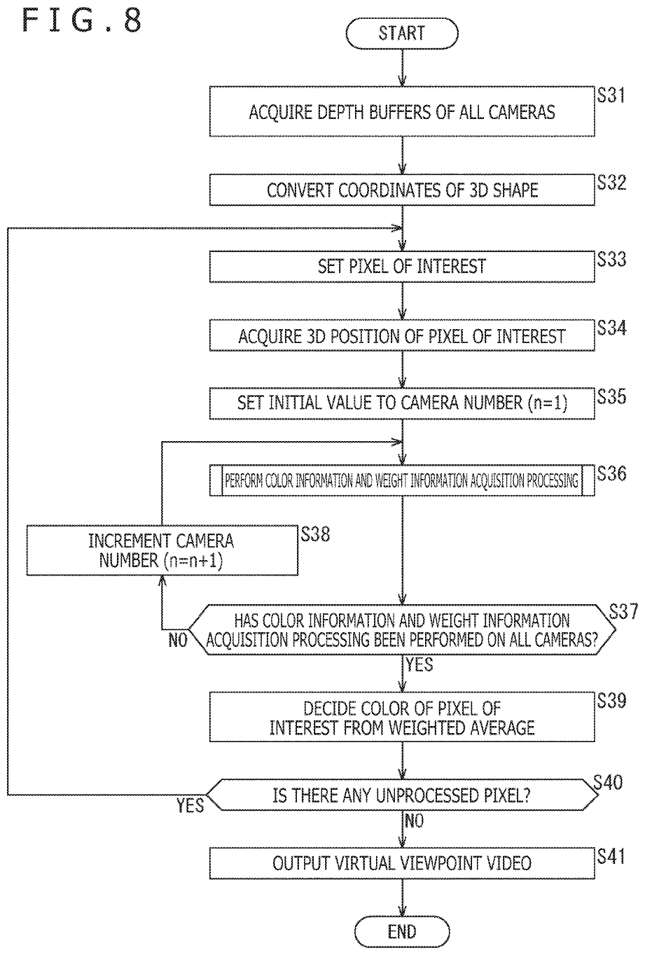

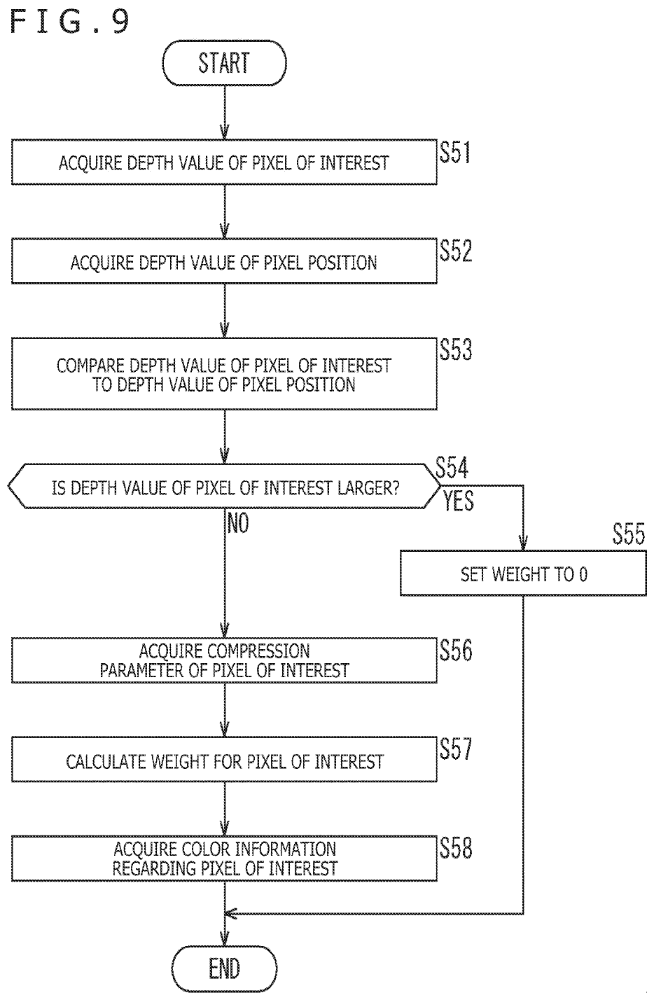

Moreover, the generation processing unit 53 performs a weighted average using weight information and color information regarding each of N images to decide a color at a predetermined position of a virtual viewpoint video, to thereby generate the virtual viewpoint video. Note that the virtual viewpoint video generation processing that the virtual viewpoint video generation unit 35 performs to generate virtual viewpoint videos is described later with reference to the flowcharts of FIG. 8 and FIG. 9.

The image transmission system 11 is configured as described above, and the multiview video transmission unit 12 sets, for overlapping regions, a compression rate higher than a compression rate for non-overlapping regions, so that the compression efficiency of compressed video data can be enhanced. Further, the arbitrary viewpoint video generation unit 13 generates a virtual viewpoint video by performing a weighted average using weight information and color information regarding each of N images, so that the quality can be enhanced.

<Detection of Overlapping Region>

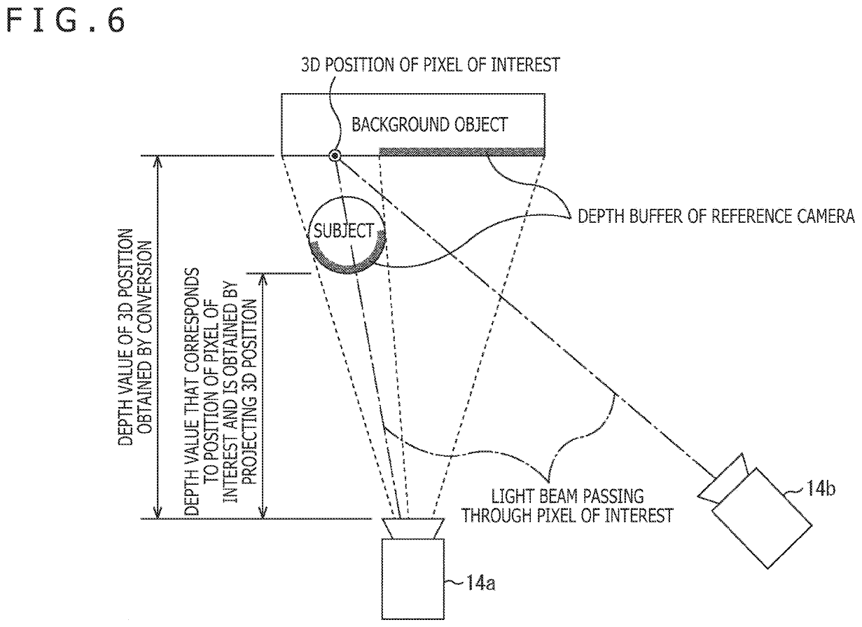

With reference to FIG. 5 and FIG. 6, a method of detecting overlapping regions is described.

FIG. 5 schematically illustrates a range captured by the reference camera 14a and a range captured by the non-reference camera 1b.

As illustrated in FIG. 5, in a case where a subject and an object behind the subject, which is another subject (referred to as “background object”), are arranged, a region of the subject observed by both the reference camera 14a and non-reference camera 1b (region d) is an overlapping region. Further, a region of the background object observed by both the reference camera 14a and non-reference camera 1b (region b) is also an overlapping region.

Meanwhile, of the region observed by the non-reference camera 1b, a region of the background object that cannot be observed by the reference camera 14a because the region is hidden in the subject (region c) is a non-overlapping region. Further, of the region observed by the non-reference camera 1b, a side surface region of the background object that does not face the reference camera 14a (region a) is also a non-overlapping region.

Then, in a case where the corresponding cameras 14-1 to 14-N are each the non-reference camera 1b, as described above, the video compression units 24-1 to 24-N set, for the overlapping regions, a compression rate higher than a compression rate for the non-overlapping regions, and perform the compression processing of compressing the images. Here, in detecting the overlapping regions, the video compression units 24-1 to 24-N determine whether or not the images overlap each other for each of pixels constituting the images, for example.

With reference to FIG. 6, a method of determining the overlap for each of the pixels constituting images is described.

First, the video compression unit 24 corresponding to the non-reference camera 1b renders the 3D shapes of subject and background object using the internal parameters and external parameters of the reference camera 14a. With this, the video compression unit 24 obtains, for each pixel of an image including the subject and background object observed from the reference camera 14a, a depth value indicating a distance from the reference camera 14a to a surface of the subject or a surface of the background object, to thereby acquire a depth buffer with respect to all the surfaces of the subject and the background object at the viewpoint of the reference camera 14a.

Next, the video compression unit 24 renders, by referring to the depth buffer of the reference camera 14a, the 3D shapes of the subject and the background object using the internal parameters and the external parameters of the non-reference camera 1b. Then, the video compression unit 24 sequentially sets the pixels constituting an image captured by the non-reference camera 1b as a pixel of interest that is a target of an overlapping region determination, and acquires a 3D position indicating the three-dimensional position of the pixel of interest in question.

In addition, the video compression unit 24 performs Model View conversion and Projection conversion on the 3D position of the pixel of interest using the internal parameters and the external parameters of the reference camera 14a, to thereby convert the 3D position of the pixel of interest to a depth value indicating a depth from the reference camera 14a to the 3D position of the pixel of interest. Further, the video compression unit 24 projects the 3D position of the pixel of interest to the reference camera 14a to identify a pixel on a light beam extending from the reference camera 14a to the 3D position of the pixel of interest, to thereby acquire, from the depth buffer of the reference camera 14a, a depth value at the pixel position of the pixel in question.

Then, the video compression unit 24 compares the depth value of the pixel of interest to the depth value of the pixel position, and sets, in a case where the depth value of the pixel of interest is larger, a non-overlapping mark to the pixel of interest in question. Meanwhile, the video compression unit 24 sets, in a case where the depth value of the pixel of interest is smaller (or is the same), an overlapping mark to the pixel of interest in question.

For example, in the case of the 3D position of a pixel of interest as illustrated in FIG. 6, since the depth value of the pixel of interest is larger than the depth value of the pixel position, the video compression unit 24 sets a non-overlapping mark to the pixel of interest in question. That is, the pixel of interest illustrated in FIG. 6 is a non-overlapping region as illustrated in FIG. 5.

Such a determination is made on all the pixels constituting the image captured by the non-reference camera 1b, so that the video compression unit 24 can detect, as overlapping regions, regions including pixels having overlapping marks set thereto.

Note that, since an actually acquired depth buffer of the reference camera 14a has numerical calculation errors, the video compression unit 24 preferably makes a determination with some latitude when determining the overlap of a pixel of interest. Further, by the overlap determination method described here, the video compression units 24-1 to 24-N can detect overlapping regions on the basis of corresponding images, the 3D shapes of the subject and the background object, and the internal parameters and external parameters of the cameras 14-1 to 14-N. That is, the video compression units 24-1 to 24-N can each compress a corresponding image (for example, an image captured by the camera 14-1 for the video compression unit 24-1) without using images other than the image in question, and therefore efficiently perform the compression processing.

<Generation of Compressed Video>

FIG. 7 is a flowchart illustrating the compressed video generation processing that the image acquisition units 21-1 to 21-N each perform to generate a compressed video.

Here, as the compressed video generation processing that the image acquisition units 21-1 to 21-N each perform, the compressed video generation processing that an n-th video compression unit 24-n of the N image acquisition units 21-1 to 21-N performs is described. Moreover, the video compression unit 24-n receives an image captured by an n-th camera 14-n from an n-th image acquisition unit 21-n. Further, the camera 14-n is the non-reference camera 1b that is not used as the reference camera 14a.

For example, the processing starts when an image captured by the camera 14-n is supplied to the video compression unit 24-n and a 3D shape acquired with the use of the image in question is supplied from the 3D shape calculation unit 23 to the video compression unit 24-n. In Step S11, the video compression unit 24-n renders, using the internal parameters and external parameters of the reference camera 14a, the 3D shape supplied from the 3D shape calculation unit 23, and acquires the depth buffer of the reference camera 14a.

In Step S12, the video compression unit 24-n renders, using the internal parameters and external parameters of the camera 14-n, which is the non-reference camera 1b, the 3D shape supplied from the 3D shape calculation unit 23.

In Step S13, the video compression unit 24-n sets a pixel of interest from the pixels of the image captured by the camera 14-n. For example, the video compression unit 24-n can set the pixel of interest in accordance with a raster order.

In Step S14, the video compression unit 24-n acquires the 3D position of the pixel of interest in the world coordinate system on the basis of depth information obtained by the rendering in Step S12 and the internal parameters and the external parameters of the camera 14-n, which is the non-reference camera 1b.

In Step S15, the video compression unit 24-n performs Model View conversion and Projection conversion on the 3D position of the pixel of interest acquired in Step S14, using the internal parameters and the external parameters of the reference camera 14a. With this, the video compression unit 24-n acquires a depth value from the reference camera 14a to the 3D position of the pixel of interest.

In Step S16, the video compression unit 24-n projects the 3D position of the pixel of interest to the reference camera 14a, and acquires, from the depth buffer of the reference camera 14a acquired in Step S11, the depth value of a pixel position on a light beam extending from the reference camera 14a to the 3D position of the pixel of interest.

In Step S17, the video compression unit 24-n compares the depth value of the pixel of interest acquired in Step S15 to the depth value of the pixel position acquired in Step S16.

In Step S18, the video compression unit 24-n determines, on the basis of the result of the comparison in Step S17, whether or not the depth value of the 3D position of the pixel of interest is larger than the depth value corresponding to the position of the pixel of interest.

In a case where the video compression unit 24-n determines in Step S18 that the depth value of the 3D position of the pixel of interest is not larger (is equal to or smaller) than the depth value corresponding to the position of the pixel of interest, the processing proceeds to Step S19. In Step S19, the video compression unit 24-n sets an overlapping mark to the pixel of interest.

Meanwhile, in a case where the video compression unit 24-n determines in Step S18 that the depth value of the 3D position of the pixel of interest is larger than the depth value corresponding to the position of the pixel of interest, the processing proceeds to Step S20. That is, in this case, the pixel of interest is in a non-overlapping region as described with the example of FIG. 6, and in Step S20, the video compression unit 24-n sets a non-overlapping mark to the pixel of interest.

After the processing in Step S19 or S20, the processing proceeds to Step S21 where the video compression unit 24-n determines whether or not the pixels constituting the image captured by the camera 14-n include any unprocessed pixel that has not been set as a pixel of interest.

In a case where the video compression unit 24-n determines in Step S21 that there are unprocessed pixels, the processing returns to Step S13. Then, in Step S13, a next pixel is set as a pixel of interest. Similar processing is repeated thereafter.

Meanwhile, in a case where the video compression unit 24-n determines in Step S21 that there is no unprocessed pixel, the processing proceeds to Step S22. That is, in this case, all the pixels constituting the image captured by the camera 14-n each have one of an overlapping mark or a non-overlapping mark set thereto. Thus, in this case, the video compression unit 24-n detects, as overlapping regions, regions including the pixels having the overlapping marks set thereto, of the pixels constituting the image captured by the camera 14-n.

In Step S22, the video compression unit 24-n sets a compression rate for each region such that a compression rate for the overlapping regions having the overlapping marks set thereto is higher than a compression rate for the non-overlapping regions having the non-overlapping marks set thereto.

In Step S23, the video compression unit 24-n compresses the image at the respective compression rates set for the overlapping regions and the non-overlapping regions in Step S22, to thereby acquire a compressed video. Then, the processing ends.

As described above, the image acquisition units 21-1 to 21-N each can detect overlapping regions in a corresponding image. Moreover, the image acquisition units 21-1 to 21-N each set, for the overlapping regions, a compression rate higher than a compression rate for non-overlapping regions in the subsequent compression processing, with the result that the compression efficiency can be enhanced.

<Generation of Virtual Viewpoint Video>

With reference to FIG. 8 and FIG. 9, the method of generating a virtual viewpoint video is described.

FIG. 8 is a flowchart illustrating the virtual viewpoint video generation processing that the virtual viewpoint video generation unit 35 performs to generate virtual viewpoint videos.

For example, the processing starts when images and compression information are supplied from the video decompression units 34-1 to 43-N to the virtual viewpoint video generation unit 35, and a 3D shape is supplied from the 3D shape data reception unit 32 to the virtual viewpoint video generation unit 35. In Step S31, the virtual viewpoint video generation unit 35 renders, using the internal parameters and the external parameters of the cameras 14-1 to 14-N, the 3D shape supplied from the 3D shape data reception unit 32, and acquires the depth buffers of all the cameras 14-1 to 14-N.

Here, in general, a frame rate in virtual viewpoint video generation and a frame rate in image acquisition by the cameras 14-1 to 14-N do not match each other in many cases. Thus, the rendering processing in Step S11 for obtaining a depth buffer is desirably performed at a timing at which a new frame is received rather than every time a virtual viewpoint video is generated.

In Step S32, the virtual viewpoint video generation unit 35 performs Model View conversion and Projection conversion on the 3D shape supplied from the 3D shape data reception unit 32 on the basis of a virtual viewpoint based on virtual viewpoint information supplied from the virtual viewpoint information acquisition unit 33. With this, the virtual viewpoint video generation unit 35 converts coordinates of the 3D shape to coordinates indicating 3D positions with the virtual viewpoint being a reference.

In Step S33, the virtual viewpoint video generation unit 35 sets a pixel of interest from the pixels of a virtual viewpoint video to be generated. For example, the virtual viewpoint video generation unit 35 can set the pixel of interest according to the raster order.

In Step S34, the virtual viewpoint video generation unit 35 acquires the 3D position of the pixel of interest on the basis of the 3D positions of the 3D shape obtained by the coordinate conversion in Step S32.

In Step S35, the virtual viewpoint video generation unit 35 sets 1 as an initial value to a camera number n identifying one of the N cameras 14-1 to 14-N.

In Step S36, the virtual viewpoint video generation unit 35 performs, on an image captured by the camera 14-n, the color information and weight information acquisition processing of acquiring a color of the pixel of interest and a weight for the color in question (see the flowchart of FIG. 9 described later).

In Step S37, the virtual viewpoint video generation unit 35 determines whether or not the color information and weight information acquisition processing has been performed on all the N cameras 14-1 to 14-N. For example, the virtual viewpoint video generation unit 35 determines that the color information and weight information acquisition processing has been performed on all the N cameras 14-1 to 14-N in a case where the camera number n is equal to or larger than N (n N).

In a case where the virtual viewpoint video generation unit 35 determines in Step S37 that the color information and weight information acquisition processing has not been performed on all the N cameras 14-1 to 14-N (n<N), the processing proceeds to Step S38. Then, in Step S38, the camera number n is incremented. After that, the processing returns to Step S36 where the processing on an image captured by the next camera 14-n starts. Similar processing is repeated thereafter.

Meanwhile, in a case where the virtual viewpoint video generation unit 35 determines in Step S37 that the color information and weight information acquisition processing has been performed on all the N cameras 14-1 to 14-N (n≥N), the processing proceeds to Step S39.

In Step S39, the virtual viewpoint video generation unit 35 calculates a weighted average using the color information and weight information acquired in the color information and weight information acquisition processing in Step S36, to thereby decide the color of the pixel of interest.

In Step S40, the virtual viewpoint video generation unit 35 determines whether or not the pixels of the virtual viewpoint video to be generated include any unprocessed pixel that has not been set as a pixel of interest.

In a case where the virtual viewpoint video generation unit 35 determines in Step S40 that there are unprocessed pixels, the processing returns to Step S33. Then, in Step S33, a next pixel is set as a pixel of interest. Similar processing is repeated thereafter.

Meanwhile, in a case where the virtual viewpoint video generation unit 35 determines in Step S40 that there is no unprocessed pixel, the processing proceeds to Step S41. That is, in this case, the colors of all the pixels of the virtual viewpoint video have been decided.

In Step S41, the virtual viewpoint video generation unit 35 generates the virtual viewpoint video such that all the pixels constituting the virtual viewpoint video are in the colors decided in Step S39, and outputs the virtual viewpoint video in question. Then, the processing ends.

FIG. 9 is a flowchart illustrating the color information and weight information acquisition processing that is executed in Step S36 of FIG. 8.

In Step S51, the virtual viewpoint video generation unit 35 performs Model View conversion and Projection conversion on the 3D position of a pixel of interest using the internal parameters and the external parameters of the camera 14-n. With this, the virtual viewpoint video generation unit 35 obtains a depth value indicating a depth from the camera 14-n to the 3D position of the pixel of interest.

In Step S52, the virtual viewpoint video generation unit 35 projects the 3D position of the pixel of interest to the camera 14-n and obtains a pixel position on a light beam passing through the 3D position of the pixel of interest on an image captured by the camera 14-n. Then, the virtual viewpoint video generation unit 35 acquires, from the depth buffer acquired in Step S31 of FIG. 8, the depth value of the pixel position on the image captured by the camera 14-n.

In Step S53, the virtual viewpoint video generation unit 35 compares the depth value of the 3D position of the pixel of interest obtained in Step S51 to the depth value of the pixel position acquired in Step S52.

In Step S54, the virtual viewpoint video generation unit 35 determines, on the basis of the result of the comparison in Step S53, whether or not the depth value of the pixel of interest is larger than the depth value of the pixel position, that is, whether the 3D position is visible or invisible from the camera 14-n. Here, since an actually acquired depth buffer of the camera 14-n has numerical calculation errors, the virtual viewpoint video generation unit 35 preferably makes a determination with some latitude when determining whether the pixel of interest is visible or invisible.

In a case where the virtual viewpoint video generation unit 35 determines in Step S54 that the depth value of the 3D position of the pixel of interest is larger than the depth value of the pixel position, the processing proceeds to Step S55.

In Step S55, the virtual viewpoint video generation unit 35 acquires weight information having a weight set to 0, and the processing ends. That is, in a case where the depth value of the 3D position of the pixel of interest is larger than the depth value of the pixel position, the 3D position of the pixel of interest is not seen from the camera 14-n (invisible region). Thus, with a weight set to 0, the color of the pixel position in question is prevented from being reflected to a virtual viewpoint video.

Meanwhile, in a case where the virtual viewpoint video generation unit 35 determines in Step S54 that the depth value of the 3D position of the pixel of interest is not larger (is equal to or smaller) than the depth value of the pixel position corresponding to the pixel of interest, the processing proceeds to Step S56. That is, in this case, the 3D position of the pixel of interest is seen from the camera 14-n (visible region).

In Step S56, the virtual viewpoint video generation unit 35 acquires, from compression information supplied from the video decompression unit 34-n, a compression parameter indicating a compression rate at the pixel position corresponding to the pixel of interest.

In Step S57, the virtual viewpoint video generation unit 35 calculates, on the basis of the compression parameter acquired in Step S56, a weight depending on a magnitude of the compression rate, to thereby acquire weight information indicating the weight in question. For example, the virtual viewpoint video generation unit 35 may use a compression rate itself as a weight or obtain a weight that may have a large value depending on a magnitude of a compression rate. Further, for example, in the case of H.264/AVC or H.265/HEVC, the QP value (quantization parameter) of a pixel of interest can be utilized as a weight. Since a higher QP value leads to a more video deterioration, a method that sets a smaller weight value for a pixel of interest having a higher QP value is desirably employed.

In Step S58, the virtual viewpoint video generation unit 35 acquires color information indicating a color at the pixel position corresponding to the pixel of interest on the image captured by the camera 14-n. With this, the color information and weight information regarding the pixel of interest of the camera 14-n are acquired, and the processing ends.

As described above, in the color information and weight information acquisition processing, the virtual viewpoint video generation unit 35 can acquire color information and weight information to decide the color of each pixel at a virtual viewpoint, thereby generating a virtual viewpoint video. With this, a higher-quality virtual viewpoint video can be presented to the viewer.

Incidentally, when a virtual viewpoint video including a captured image as a texture is generated, in a case where the angle of the surface of a subject with respect to the camera 14 that has captured the image in question is sharp, an area of the captured image that corresponds to the region having the sharp angle becomes smaller than the model area, resulting in a reduction in texture resolution.

Accordingly, in the image transmission system 11 illustrated in FIG. 1, for example, with regard to a region in which the surface of a subject has a sharp angle, with the camera 14 being the origin, an angle between the direction of a light beam vector extending to the three-dimensional point of the model and the normal vector of the three-dimensional point of the model is acquired by calculation. Then, an inner product of the light beam vector and the normal vector, each of which is a unit vector, is obtained, and a value of the inner product is cos(e) between the vectors.

Thus, the inner product of the light beam vector and the normal vector is a value of from −1 to 1. Note that an inner product of the light beam vector and the normal vector that is 0 or smaller indicates the back surface of the model. Thus, with regard to the inner product of the light beam vector and the normal vector, when attention is paid to a range of from 0 to 1, an inner product closer to 0 means that the subject has a sharper angle to the camera 14. Further, this inner product can be obtained using the internal parameters and the external parameters of the camera 14 and the 3D shape, and it is not necessary to use an image captured by the camera 14.

On the basis of such a characteristic, the image transmission system 11 can also use, in the processing of detecting overlapping regions, the inner product of the light beam vector and the normal vector of the non-reference camera 1b (angle information) as a reference value. In this case, even when a pixel of interest is in an overlapping region, in a case where the inner product of the light beam vector and the normal vector of the reference camera 14a is small, the above-mentioned processing of setting a higher compression rate is stopped (that is, a higher compression rate is not set), so that a deterioration in quality of a virtual viewpoint video can be further reduced.

<Second Configuration Example of Image Transmission System>

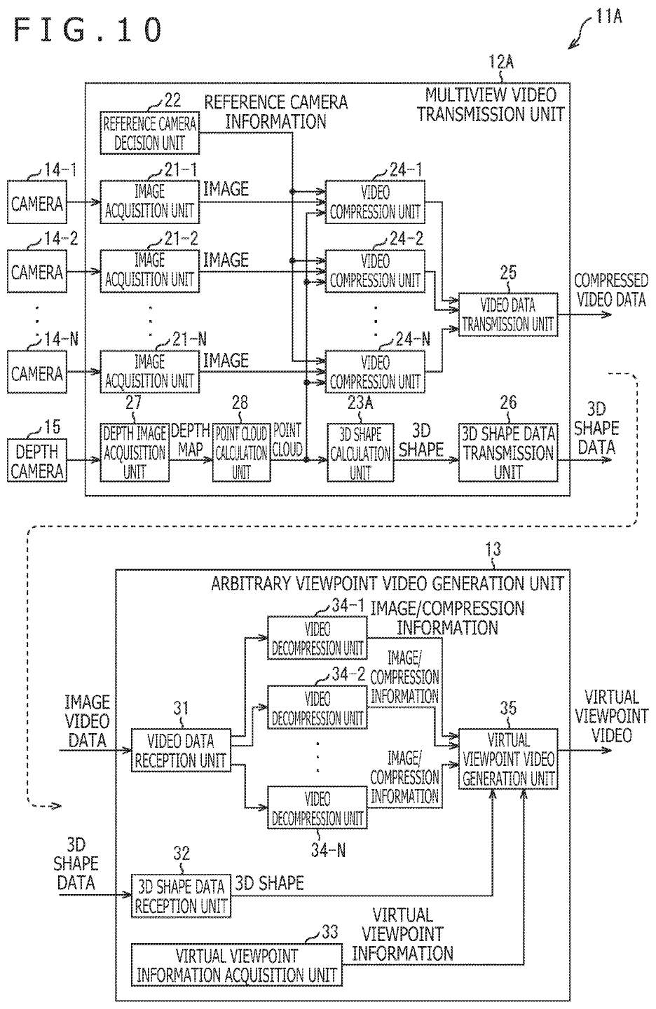

FIG. 10 is a block diagram illustrating a configuration example of a second embodiment of the image transmission system to which the present technology is applied. Note that, in an image transmission system 11A illustrated in FIG. 10, configurations similar to those of the image transmission system 11 of FIG. 1 are denoted by the same reference signs, and the detailed descriptions thereof are omitted.

As illustrated in FIG. 10, the image transmission system 11A includes a multiview video transmission unit 12A and the arbitrary viewpoint video generation unit 13. The configuration of the arbitrary viewpoint video generation unit 13 is similar to the one illustrated in FIG. 1. Further, the multiview video transmission unit 12A is similar to the multiview video transmission unit 12 of FIG. 1 in terms of including the N image acquisition units 21-1 to 21-N, the reference camera decision unit 22, the N video compression units 24-1 to 24-N, the video data transmission unit 25, and the 3D shape data transmission unit 26.

Meanwhile, the image transmission system 11A is different from the configuration illustrated in FIG. 1 in that a depth camera 15 is connected to the multiview video transmission unit 12A and that the multiview video transmission unit 12A includes a depth image acquisition unit 27, a point cloud calculation unit 28, and a 3D shape calculation unit 23A.

The depth camera 15 supplies a depth image having a depth to a subject to the multiview video transmission unit 12A.

The depth image acquisition unit 27 acquires a depth image supplied from the depth camera 15, creates a subject depth map on the basis of the depth image in question, and supplies the subject depth map to the point cloud calculation unit 28.

The point cloud calculation unit 28 performs calculation including projecting a subject depth map supplied from the depth image acquisition unit 27 to a 3D space, thereby acquiring point cloud information regarding the subject, and supplies the point cloud information to the video compression units 24-1 to 24-N and the 3D shape calculation unit 23A.

Thus, the 3D shape calculation unit 23A performs calculation based on point cloud information regarding a subject supplied from the point cloud calculation unit 28, thereby acquiring the 3D shape of the subject. In a similar manner, the video compression units 24-1 to 24-N can use point cloud information regarding a subject instead of the 3D shape of the subject.

As in the case of the 3D shape calculation unit 23 of FIG. 1, a processing load of the processing of restoring the 3D shape of a subject from an image is generally high. In contrast to this, as in the case of the 3D shape calculation unit 23A, the processing load of the processing of generating a 3D shape from point cloud information regarding a subject is low since the 3D shape can be uniquely converted from the internal parameters and external parameters of the depth camera 15.

Thus, the image transmission system 11A has an advantage over the image transmission system 11 of FIG. 1 in that the image transmission system 11A can reduce the processing load.

Note that, in the image transmission system 11A, the compressed video generation processing of FIG. 7, the virtual viewpoint video generation processing of FIG. 8, and the like are performed like the processing described above. Further, the image transmission system 11A may use the plurality of depth cameras 15. In the case of such a configuration, 3D information regarding a region occluded from the depth camera 15 at a single viewpoint can be obtained, and a more accurate determination can thus be made.

Further, point cloud information regarding a subject obtained by the point cloud calculation unit 28 is information sparser than a 3D shape obtained by the 3D shape calculation unit 23 of FIG. 1. Thus, a 3D mesh may be generated from point cloud information regarding a subject, and an overlap determination may be made using the 3D mesh in question. In addition, to obtain a more accurate 3D shape, for example, not only a depth image obtained by the depth camera 15, but also images obtained by the cameras 14-1 to 14-N may be used.

<Third Configuration Example of Image Transmission System>

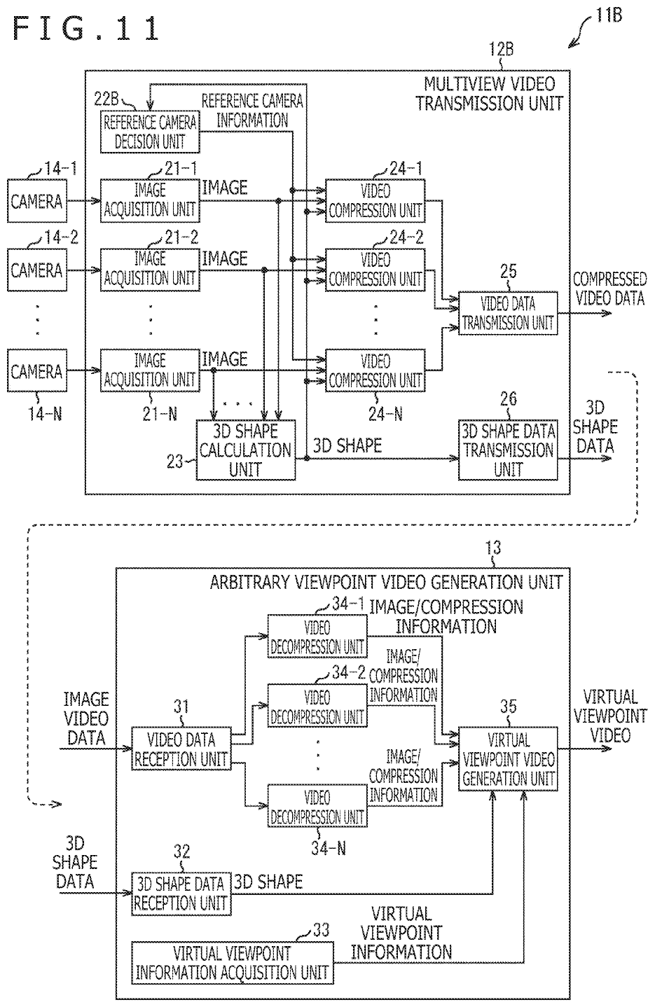

FIG. 11 is a block diagram illustrating a configuration example of a third embodiment of the image transmission system to which the present technology is applied. Note that, in an image transmission system 11B illustrated in FIG. 11, configurations similar to those of the image transmission system 11 of FIG. 1 are denoted by the same reference signs, and the detailed descriptions thereof are omitted.

As illustrated in FIG. 11, the image transmission system 11B includes a multiview video transmission unit 12B and the arbitrary viewpoint video generation unit 13. The configuration of the arbitrary viewpoint video generation unit 13 is similar to the one illustrated in FIG. 1. Further, the multiview video transmission unit 12B is similar to the multiview video transmission unit 12 of FIG. 1 in terms of including the N image acquisition units 21-1 to 21-N, the 3D shape calculation unit 23, the N video compression units 24-1 to 24-N, the video data transmission unit 25, and the 3D shape data transmission unit 26.

Meanwhile, the multiview video transmission unit 12B is different from the configuration illustrated in FIG. 1 in that the multiview video transmission unit 12B includes a reference camera decision unit 22B and that the 3D shape of a subject output from the 3D shape calculation unit 23B is supplied to the reference camera decision unit 22B.

The reference camera decision unit 22B decides the reference camera 14a on the basis of the 3D shape of a subject supplied from the 3D shape calculation unit 23.

Here, the resolution of the texture of an arbitrary viewpoint video that is presented to the viewer depends on a distance between the camera 14 and a subject, and as the distance from the camera 14 to the subject is shorter, the resolution is higher. As described above, in compressing an image captured by the non-reference camera 1b, the video compression units 24-1 to 24-N set a high compression rate for overlapping regions with an image captured by the reference camera 14a. Thus, the video quality of an arbitrary viewpoint video that is presented to the viewer heavily depends on the quality of an image captured by the reference camera 14a.

Thus, the reference camera decision unit 22B obtains, on the basis of the 3D shape of a subject supplied from the 3D shape calculation unit 23, distances from the cameras 14-1 to 14-N to the subject, and decides the camera 14 closest to the subject as the reference camera 14a. For example, the reference camera decision unit 22B can obtain distances from the cameras 14-1 to 14-N to the subject using the 3D shape of the subject and the external parameters of the cameras 14-1 to 14-N.

Thus, in the image transmission system 11B, the reference camera 14a closest to a subject is utilized, so that the quality of a virtual viewpoint video can be enhanced.

<Fourth Configuration Example of Image Transmission System>

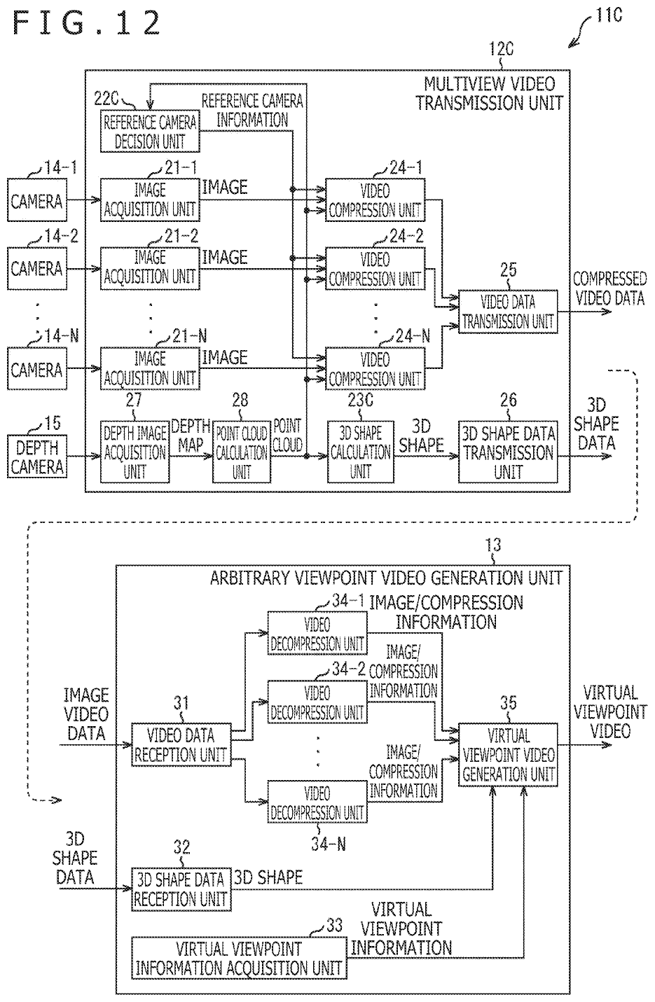

FIG. 12 is a block diagram illustrating a configuration example of a fourth embodiment of the image transmission system to which the present technology is applied. Note that, in an image transmission system 11C illustrated in FIG. 12, configurations similar to those of the image transmission system 11 of FIG. 1 are denoted by the same reference signs, and the detailed descriptions thereof are omitted.

As illustrated in FIG. 12, the image transmission system 11C includes a multiview video transmission unit 12C and the arbitrary viewpoint video generation unit 13. The configuration of the arbitrary viewpoint video generation unit 13 is similar to the one illustrated in FIG. 1. Further, the multiview video transmission unit 12C is similar to the multiview video transmission unit 12 of FIG. 1 in terms of including the N image acquisition units 21-1 to 21-N, the N video compression units 24-1 to 24-N, the video data transmission unit 25, and the 3D shape data transmission unit 26.

Meanwhile, the image transmission system 11C is different from the configuration illustrated in FIG. 1 in that the depth camera 15 is connected to the multiview video transmission unit 12C and that the multiview video transmission unit 12C includes a reference camera decision unit 22C, the depth image acquisition unit 27, the point cloud calculation unit 28, and a 3D shape calculation unit 23C. That is, the image transmission system 11C utilizes a depth image acquired by the depth camera 15, like the image transmission system 11A of FIG. 10.

In addition, in the image transmission system 11C, point cloud information regarding a subject output from the point cloud calculation unit 28 is supplied to the reference camera decision unit 22C, and the reference camera 14a is decided on the basis of the point cloud information regarding the subject, like the image transmission system 11B of FIG. 11.

In this way, the configuration of the image transmission system 11C is the combination of the image transmission system 11A of FIG. 10 and the image transmission system 11B of FIG. 11.

Note that, the method of deciding the reference camera 14a is not limited to the decision method based on the 3D shape of a subject or point cloud information regarding the subject, and still another decision method may be employed.

<Fifth Configuration Example of Image Transmission System>

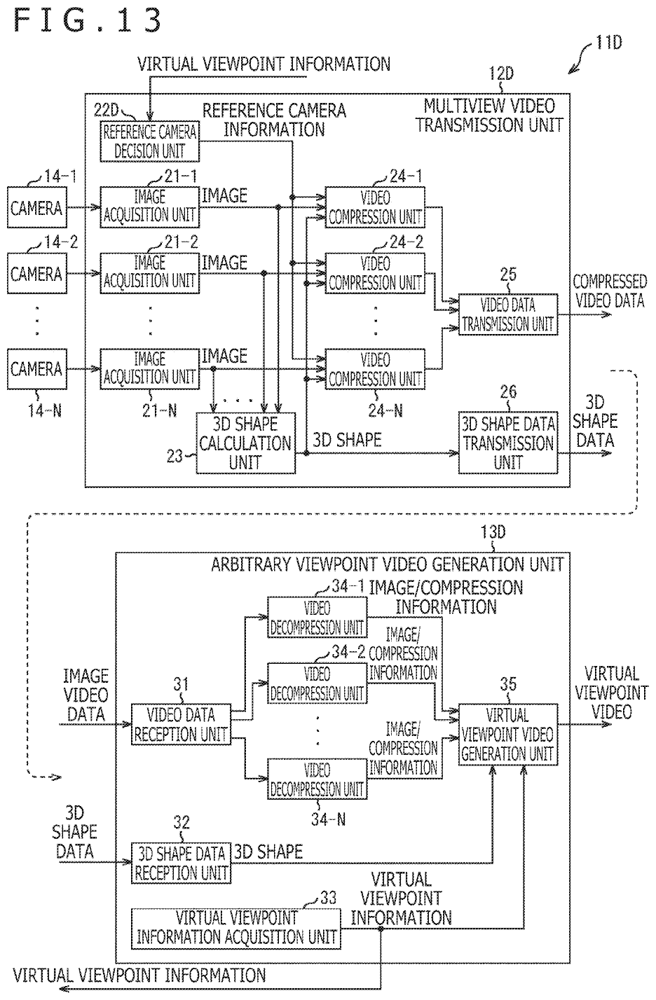

FIG. 13 is a block diagram illustrating a configuration example of a fifth embodiment of the image transmission system to which the present technology is applied. Note that, in an image transmission system 11D illustrated in FIG. 13, configurations similar to those of the image transmission system 11 of FIG. 1 are denoted by the same reference signs, and the detailed descriptions thereof are omitted.

As illustrated in FIG. 13, the image transmission system 11D includes a multiview video transmission unit 12D and an arbitrary viewpoint video generation unit 13D.

The multiview video transmission unit 12D is similar to the multiview video transmission unit 12 of FIG. 1 in terms of including the N image acquisition units 21-1 to 21-N, the 3D shape calculation unit 23, the N video compression units 24-1 to 24-N, the video data transmission unit 25, and the 3D shape data transmission unit 26. However, the multiview video transmission unit 12D is different from the multiview video transmission unit 12 of FIG. 1 in terms of including a reference camera decision unit 22D.

The arbitrary viewpoint video generation unit 13D is similar to the arbitrary viewpoint video generation unit 13 of FIG. 1 in terms of including the video data reception unit 31, the 3D shape data reception unit 32, the virtual viewpoint information acquisition unit 33, the N video decompression units 34-1 to 43-N, and the virtual viewpoint video generation unit 35. However, the arbitrary viewpoint video generation unit 13D is different from the arbitrary viewpoint video generation unit 13 of FIG. 1 in that virtual viewpoint information output from the virtual viewpoint information acquisition unit 33 is transmitted to the multiview video transmission unit 12D.

That is, in the image transmission system 11D, virtual viewpoint information is transmitted from the arbitrary viewpoint video generation unit 13D to the multiview video transmission unit 12D, and the reference camera decision unit 22D decides the reference camera 14a by utilizing the virtual viewpoint information. For example, the reference camera decision unit 22D selects, as the reference camera 14a, the camera 14 of the cameras 14-1 to 14-N that is closest in terms of distance and angle to a virtual viewpoint from which the viewer sees a subject.

For example, in applications such as live distribution, the reference camera decision unit 22D checks the positions and postures of the cameras 14-1 to 14-N with the position and posture of a virtual viewpoint to decide the reference camera 14a, so that the quality of a virtual viewpoint video that is presented to the viewer can be enhanced.

Note that the method of deciding the reference camera 14a is not limited to the method that selects the camera 14 closest in terms of distance and angle. For example, the reference camera decision unit 22D may employ a method that predicts a current viewing position from past virtual viewpoint information, and selects the reference camera 14a on the basis of the prediction.

<Example of Using Plurality of Reference Cameras>

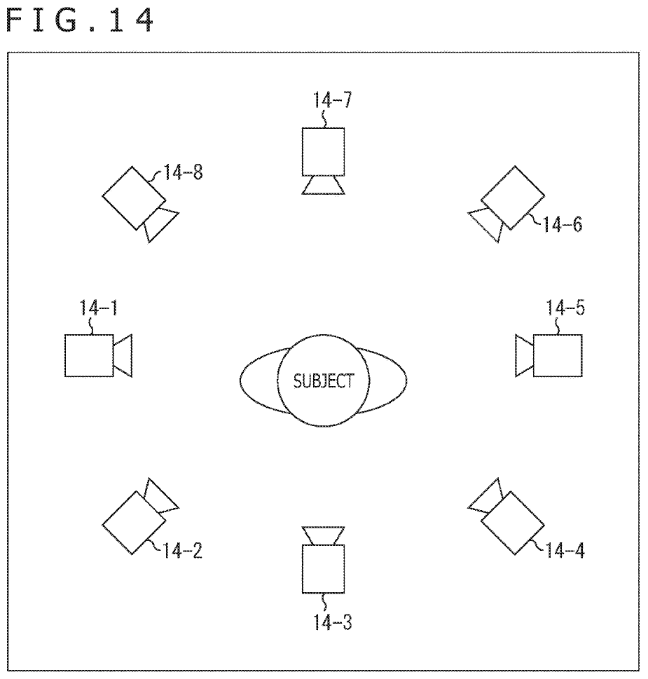

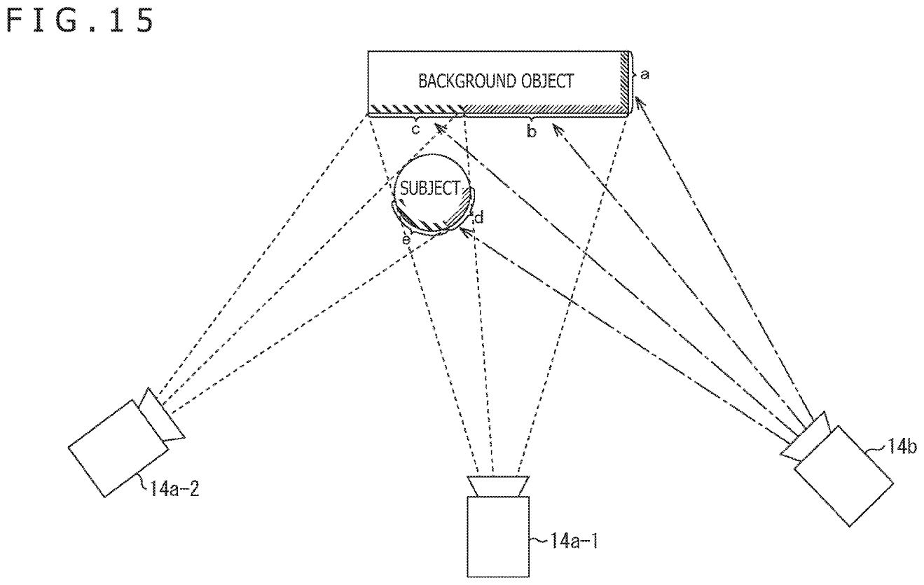

With reference to FIG. 14 and FIG. 15, an example in which the plurality of reference cameras 14a is used is described.

For example, the plurality of cameras 14 can be arranged to surround a subject. In the example illustrated in FIG. 14, eight cameras 14-1 to 14-8 are arranged to surround a subject.

In a case where the plurality of cameras 14 is used in this way, the non-reference camera 1b may be arranged on the opposite side of the reference camera 14a across a subject in some cases. Thus, it is assumed that an image captured by the non-reference camera 1b arranged on the opposite side of the reference camera 14a across the subject overlaps an image captured by the reference camera 14a in a quite small area.

Thus, in this case, the plurality of reference cameras 14a is used, so that the situation where images overlap each other in a small area can be avoided. For example, the camera 14 arranged on the opposite side of the first reference camera 14a across a subject is decided as the second reference camera 14a. Further, three or more reference cameras 14a may be used. Note that the reference camera 14a may be decided by a method other than the method that decides the reference camera 14a in this way.

Here, in a case where the plurality of reference cameras 14a is set, in the processing of detecting overlapping regions with an image captured by the non-reference camera 1b, an overlap with each of the reference cameras 14a is determined.

An example in which overlapping regions between images captured by two reference cameras 14a-1 and 14a-2 and an image captured by the non-reference camera 1b are detected as illustrated in FIG. 15, for example, is described as with the example of FIG. 5 described above.

For example, as illustrated in FIG. 15, a region “a” of a background object is a non-overlapping region that is observed only by the non-reference camera 1b. Further, a region “b” of the background object is an overlapping region that is observed by the reference camera 14a-1 and the non-reference camera 1b. Further, a region “c” of the background object is an overlapping region that cannot be observed by the reference camera 14a-1 because the region is hidden in a subject but is observed by the reference camera 14a-2 and the non-reference camera 1b. Further, a region “d” of the subject is an overlapping region that is observed by the reference camera 14a-1 and the non-reference camera 1b. Moreover, a region “e” of the subject is an overlapping region that is observed by the reference cameras 14a-1 and 14a-2.

In the compressed video generation processing using the plurality of reference cameras 14a in this way, the depth buffer of each of the reference cameras 14a is acquired in advance. Then, in the overlap determination of each pixel, a comparison is made with the depth buffer of each of the reference cameras 14a, and in a case where a pixel is visible from at least one of the reference cameras 14a, an overlapping mark is set to the pixel in question.

In this way, with the use of the plurality of reference cameras 14a, the number of pixels having overlapping marks set thereto can be increased in the non-reference camera 1b. Thus, the number of the overlapping regions in the image captured by the non-reference camera 1b can be increased, with the result that the data amount of the image in question can be further reduced.

Here, for a region in which the plurality of reference cameras 14a overlaps each other, like the region “e” illustrated in FIG. 15, a still higher compression rate can be applied. With this, the data amount can be reduced more effectively.

<Example of Utilizing Viewer Viewpoint in Video Compression>

In the configuration in which virtual viewpoint information is transmitted from the arbitrary viewpoint video generation unit 13D to the multiview video transmission unit 12D, like the image transmission system 11D illustrated in FIG. 13 described above, the virtual viewpoint information that is provided to the viewer can be utilized as additional video compression information.

For example, a virtual viewpoint video that is provided to the viewer is generated by projecting a 3D model to a virtual viewpoint, and a region invisible from the virtual viewpoint is unnecessary information that cannot be seen from the viewer. Thus, on the basis of virtual viewpoint information, information indicating whether regions are visible or invisible from a virtual viewpoint is utilized, and a still higher compression rate can be set for the invisible regions. With this, for example, in applications such as live streaming, compressed video data can be transmitted with less delay.

Further, regions invisible from a virtual viewpoint is the out-of-field-angle regions or occluded regions of the virtual viewpoint. Information regarding these regions can be obtained by rendering a 3D shape from the virtual viewpoint once and acquiring a depth buffer.

That is, whether a region of a 3D shape is visible or invisible from a virtual viewpoint can be recognized from virtual viewpoint information and 3D shape information. This information is utilized, and the processing of filling regions invisible from the virtual viewpoint with a certain color is employed, with the result that the compression efficiency can be further enhanced without a reduction in quality of a virtual viewpoint video that is presented to the viewer. Note that, in actual operation, there is a communication delay between the multiview video transmission unit 12D and the arbitrary viewpoint video generation unit 13D, and hence, the measure of giving a buffer to the range of motion of the viewer is preferably taken, for example.

As described above, by using images captured by the plurality of cameras 14 from multiple viewpoints, the image transmission system 11 of each embodiment can effectively enhance the compression efficiency while preventing the video deterioration of a virtual viewpoint video from an arbitrary viewpoint that is presented to the viewer.

Note that the overlap determination processing, the visible and invisible determination processing, the weighted average processing, and the like that are performed for each pixel in the description above may be performed for each block utilized in the compression technology, for example.

<Configuration Example of Computer>

Note that each processing described with reference to the above-mentioned flowcharts is not necessarily performed chronologically in the order described in the flowcharts. The processing includes processes that are executed in parallel or individually as well (for example, parallel processing or subject-based processing). Further, the program may be processed by a single CPU or by a plurality of CPUs in a distributed manner.

Further, the series of processes (image processing method) described above can be executed by hardware or software. In a case where the series of processing processes is executed by software, a program configuring the software is installed from a program recording medium having recorded thereon the program on a computer incorporated in dedicated hardware or a general-purpose personal computer capable of executing various functions with various programs installed thereon, for example.

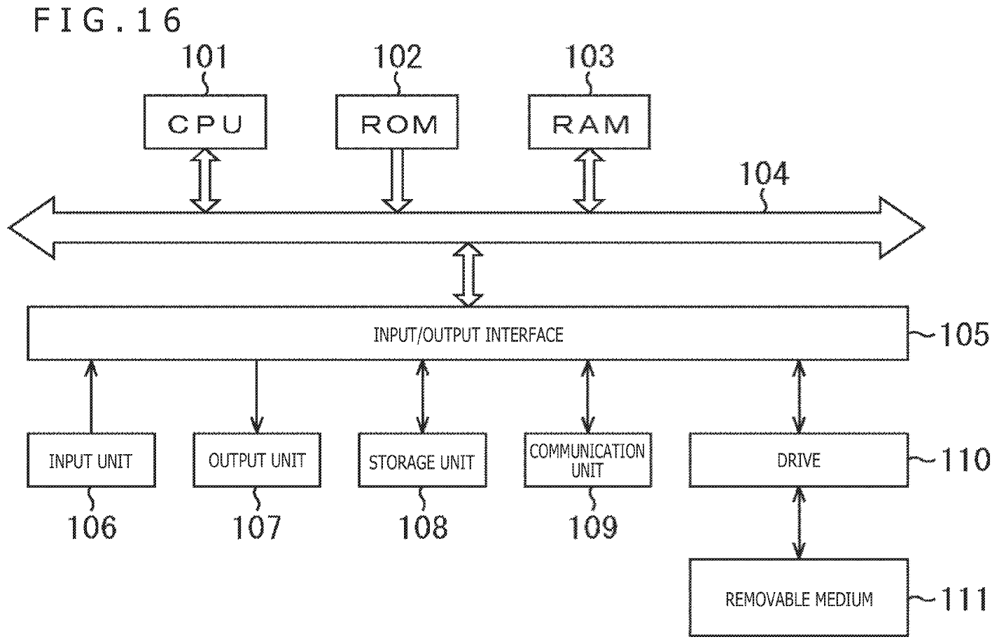

FIG. 16 is a block diagram illustrating a configuration example of the hardware of a computer configured to execute the above-mentioned series of processes with the program.

In the computer, a CPU (Central Processing Unit) 101, a ROM (Read Only Memory) 102, and a RAM (Random Access Memory) 103 are connected to each other by a bus 104.

An input/output interface 105 is further connected to the bus 104. To the input/output interface 105, an input unit 106 including a keyboard, a mouse, a microphone, etc., an output unit 107 including a display, a speaker, etc., a storage unit 108 including a hard disk, a non-volatile memory, etc., a communication unit 109 including a network interface, etc., and a drive 110 configured to drive a removable medium 111 such as a magnetic disk, an optical disc, a magneto-optical disc, or a semiconductor memory are connected.

In the computer configured as described above, the CPU 101 loads, for example, the program stored in the storage unit 108 into the RAM 103 through the input/output interface 105 and the bus 104 and executes the program to perform the series of processes described above.

The program that is executed by the computer (CPU 101) is provided through the removable medium 111 having the program recorded thereon. The removable medium 111 is a package medium including, for example, a magnetic disk (including a flexible disk), an optical disc (CD-ROM (Compact Disc-Read Only Memory), a DVD (Digital Versatile Disc), or the like), a magneto-optical disc, or a semiconductor memory. Alternatively, the program is provided through a wired or wireless transmission medium such as a local area network, the Internet, or digital satellite broadcasting.

Moreover, the program can be installed on the storage unit 108 through the input/output interface 105 with the removable medium 111 mounted on the drive 110. Further, the program can be received by the communication unit 109 through a wired or wireless transmission medium to be installed on the storage unit 108. Besides, the program can be installed on the RAM 102 or the storage unit 108 in advance.

<Combination Example of Configurations>

Note that, the present technology can also take the following configurations.
(1)

An image processing device including:

a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and

a compression unit configured to compress the image at each of the compression rates.
(2)

The image processing device according to (1), further including:

a detection unit configured to detect the overlapping region on the basis of information indicating a three-dimensional shape of the subject.
(3)

The image processing device according to (1), further including:

an acquisition unit configured to acquire the image to supply the image to the compression unit.
(4)

The image processing device according to (1), in which the setting unit sets the compression rate for the overlapping region using angle information indicating an angle between a light beam vector extending from the reference imaging device to a predetermined point on a surface of the subject and a normal vector at the predetermined point.
(5)

The image processing device according to (1) or (2), further including:

a 3D shape calculation unit configured to calculate information indicating a three-dimensional shape of the subject from the plurality of the images obtained by imaging the subject by the plurality of the imaging devices from the plurality of viewpoints.
(6)

The image processing device according to any of (1) to (3), further including:

a depth image acquisition unit configured to acquire a depth image having a depth to the subject; and
a point cloud calculation unit configured to calculate, as information indicating a three-dimensional shape of the subject, point cloud information regarding the subject on the basis of the depth image.
(7)

The image processing device according to any of (1) to (4), further including:

a reference imaging device decision unit configured to decide the reference imaging device from the plurality of the imaging devices.
(8)

The image processing device according to (5),

in which the reference imaging device decision unit decides the reference imaging device on the basis of distances from the plurality of the imaging devices to the subject.
(9)

The image processing device according to (5) or (6),

in which the reference imaging device decision unit decides the reference imaging device on the basis of information indicating a virtual viewpoint that is used in generating a virtual viewpoint video of the subject from an arbitrary viewpoint.
(10)

The image processing device according to any of (1) to (9), in which the reference imaging device includes two or more imaging devices of the plurality of the imaging devices.
(11)

The image processing device according to any of (1) to (10),

in which the setting unit sets the compression rate on the basis of information indicating a virtual viewpoint that is used in generating a virtual viewpoint video of the subject from an arbitrary viewpoint.
(12)

An image processing method including:

by an image processing device which compresses an image,

setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and

compressing the image at each of the compression rates.
(13)

A program causing a computer of an image processing device which compresses an image to execute image processing including:

setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and

compressing the image at each of the compression rates.
(14)

An image processing device including:

a determination unit configured to determine, for each of a plurality of images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject;

a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and

a generation unit configured to generate the virtual viewpoint video on the basis of the color decided by the decision unit.
(15)

An image processing method including:

by an image processing device which generates an image,

determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject;

performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and

generating the virtual viewpoint video on the basis of the color decided.
(16)

A program causing a computer of an image processing device which generates an image to execute image processing including:

determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on the basis of information indicating a three-dimensional shape of the subject;

performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and

generating the virtual viewpoint video on the basis of the color decided.
(17)

An image transmission system including:

a first image processing device including
a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and
a compression unit configured to compress the image at each of the compression rates; and

a second image processing device including
a determination unit configured to determine, for each of the plurality of images transmitted from the first image processing device, whether a predetermined position of the subject from an arbitrary viewpoint on a virtual viewpoint video is a visible region or an invisible region in each of the plurality of the imaging devices on the basis of information indicating a three-dimensional shape of the subject,
a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and
a generation unit configured to generate the virtual viewpoint video on the basis of the color decided by the decision unit.

Note that the present embodiment is not limited to the embodiments described above, and various modifications can be made without departing from the gist of the present disclosure. Further, the effects described herein are merely exemplary and are not limited, and other effects may be provided.

### REFERENCE SIGNS LIST

11 Image transmission system, 12 Multiview video transmission unit, 13 Arbitrary viewpoint video generation unit, Camera, 14a Reference camera, 1b Non-reference camera, 15 Depth camera, 21 Image acquisition unit, 22 Reference camera decision unit, 23 3D shape calculation unit, 24 Video compression unit, 25 Video data transmission unit, 26 3D shape data transmission unit, 27 Depth image acquisition unit, 28 Point cloud calculation unit, 31 Video data reception unit, 32 3D shape data reception unit, 33 Virtual viewpoint information acquisition unit, 34 Video decompression unit, 35 Virtual viewpoint video generation unit

1. An image processing device comprising:
a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and
a compression unit configured to compress the image at each of the compression rates.

2. The image processing device according to claim 1, further comprising:
a detection unit configured to detect the overlapping region on a basis of information indicating a three-dimensional shape of the subject.

3. The image processing device according to claim 1, further comprising:
an acquisition unit configured to acquire the image to supply the image to the compression unit.

4. The image processing device according to claim 1,
wherein the setting unit sets the compression rate for the overlapping region using angle information indicating an angle between a light beam vector extending from the reference imaging device to a predetermined point on a surface of the subject and a normal vector at the predetermined point.

5. The image processing device according to claim 1, further comprising:
a 3D shape calculation unit configured to calculate information indicating a three-dimensional shape of the subject from the plurality of the images obtained by imaging the subject by the plurality of the imaging devices from the plurality of viewpoints.

6. The image processing device according to claim 1, further comprising:
a depth image acquisition unit configured to acquire a depth image having a depth to the subject; and
a point cloud calculation unit configured to calculate, as information indicating a three-dimensional shape of the subject, point cloud information regarding the subject on a basis of the depth image.

7. The image processing device according to claim 1, further comprising:
a reference imaging device decision unit configured to decide the reference imaging device from the plurality of the imaging devices.

8. The image processing device according to claim 7,
wherein the reference imaging device decision unit decides the reference imaging device on a basis of distances from the plurality of the imaging devices to the subject.

9. The image processing device according to claim 7,
wherein the reference imaging device decision unit decides the reference imaging device on a basis of information indicating a virtual viewpoint that is used in generating a virtual viewpoint video of the subject from an arbitrary viewpoint.

10. The image processing device according to claim 1,
wherein the reference imaging device includes two or more imaging devices of the plurality of the imaging devices.

11. The image processing device according to claim 1,
wherein the setting unit sets the compression rate on a basis of information indicating a virtual viewpoint that is used in generating a virtual viewpoint video of the subject from an arbitrary viewpoint.

12. An image processing method comprising:
by an image processing device which compresses an image,
setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and
compressing the image at each of the compression rates.

13. A program causing a computer of an image processing device which compresses an image to execute image processing comprising:
setting a compression rate for an overlapping region in which, of a plurality of the images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region; and
compressing the image at each of the compression rates.

14. An image processing device comprising:
a determination unit configured to determine, for each of a plurality of images obtained by capturing a subject from a plurality of viewpoints, whether a predetermined position of the subject from an arbitrary viewpoint on a virtual viewpoint video is a visible region or an invisible region in each of a plurality of the imaging devices on a basis of information indicating a three-dimensional shape of the subject;
a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and
a generation unit configured to generate the virtual viewpoint video on a basis of the color decided by the decision unit.

15. An image processing method comprising:
by an image processing device which generates an image,
determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on a basis of information indicating a three-dimensional shape of the subject;
performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and
generating the virtual viewpoint video on a basis of the color decided.

16. A program causing a computer of an image processing device which generates an image to execute image processing comprising:
determining, for each of a plurality of the images obtained by capturing a subject from a plurality of viewpoints, whether a predetermined position of the subject from an arbitrary viewpoint on a virtual viewpoint video is a visible region or an invisible region in each of a plurality of the imaging devices on a basis of information indicating a three-dimensional shape of the subject;
performing a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video; and
generating the virtual viewpoint video on a basis of the color decided.

17. An image transmission system comprising:
a first image processing device including
a setting unit configured to set a compression rate for an overlapping region in which, of a plurality of images obtained by capturing a subject by a plurality of imaging devices from a plurality of viewpoints, the image captured by a reference imaging device, which serves as a reference, and the image captured by a non-reference imaging device other than the reference imaging device overlap each other, higher than a compression rate for a non-overlapping region, and
a compression unit configured to compress the image at each of the compression rates; and
a second image processing device including
a determination unit configured to determine, for each of the plurality of images transmitted from the first image processing device, whether a predetermined position of the subject from an arbitrary viewpoint on a virtual viewpoint video is a visible region or an invisible region in each of the plurality of the imaging devices on a basis of information indicating a three-dimensional shape of the subject,
a decision unit configured to perform a weighted average using weight information based on a compression rate used in compressing a position corresponding to the predetermined position determined as the visible region on each of the plurality of the images, and color information indicating a color at the position corresponding to the predetermined position on each image, to thereby decide a color at the predetermined position of the virtual viewpoint video, and
a generation unit configured to generate the virtual viewpoint video on a basis of the color decided by the decision unit.
